(19) United States
(12) Patent Application Publication
(10) Pub. No.: US 2013/0340908 A1
(43) Pub. Date: Dec. 26, 2013

(54) OUTER BEAD LOCK WHEEL

(71) Applicants: Adam Wirth, Belleville, MI (US); Matt R. Bagley, Belleville, MI (US)

(72) Inventors: Adam Wirth, Belleville, MI (US); Matt R. Bagley, Belleville, MI (US)

(21) Appl. No.: 13/607,772

(22) Filed: Sep. 9, 2012

Related U.S. Application Data
(60) Provisional application No. 61/662,842, filed on Jun. 21, 2012.

(51) Int. Cl. B60B 25/10; B60B 25/20; B60C 19/00; B60B 7/01

(52) U.S. Cl. 152/450; 301/37.24; 301/11.1

(57) ABSTRACT

The outer bead lock wheel of the present disclosure provides for wheel and tire flexibility between off-road vehicle capability and on-road vehicle capability by securing the tire to the wheel regardless of the change in tire pressure. The outer bead lock wheel of the present disclosure includes a wheel base having a flange which is operatively configured to receive one of a decorative ring or a functional ring. The decorative ring may be mechanically affixed to the wheel base, and the functional ring may also be mechanically affixed to the wheel base.

### RELATED APPLICATIONS

This patent application claims the benefit of U.S. Provisional 61/662,842 filed on Jun. 21, 2012.

### BACKGROUND

The present disclosure generally relates to a wheel design for pneumatic tubeless tires that convert from a standard tubeless tires mounted design to a locked outer bead wheel design.

Conventional wheels for mounting tubeless tires have a hub formed with peripheral flanges for abutting and sealing the beads on each side of the tubeless type tires. A frequent problem with these wheels is that when cornering, the centrifugal force on the tire can cause a separation of the bead from the rim, resulting in the loss of air. This deflates the tire, requiring reinflation of the tire at frequent intervals. Alternatively, some users of vehicles may prefer to change to low tire pressure when those users engage in off-road driving in order to obtain optimum traction.

For example, when driving in sandy conditions, it is generally desirable to have low pressure within the tires in order to obtain the desired traction. A traditional wheel cannot keep a tire bead firmly locked to the rim when the pressure within the tire is low. It is undesirable to have a tire which separates from the wheel.

The wheels that have been previously designed for such low pressure tires provide a means to clamp the beads of a tire. These wheels, however, provide a flange on the hub which cooperates with another member to apply axial forces on either side of the bead. However, these clamping components are generally of a planar construction and have a heavy weight. These wheels furthermore are designed for use only with low pressure tires. Furthermore, this type of design generally requires a very complicated configuration in order to hold the tire in place.

It is further undesirable to change the wheels every time the tires are changed from a higher pressure to a lower pressure. This is a time consuming, labor intensive, and expensive system to have on a vehicle which uses both higher tire pressure and lower tire pressure.

Therefore, it is an object of the present disclosure to provide a wheel design that can be used for mounting pneumatic tubeless tires that can convert from the standard tubeless tires to a wheel having a locked outer bead design such that the wheel can hold the same tire in place whether the pressure within the tire decreases or increases.

### SUMMARY

An outer bead lock wheel for use with pneumatic tubeless tires is provided according to the embodiment(s) disclosed herein. The outer bead lock wheel of the present disclosure provides for wheel and tire flexibility between off-road vehicle capability and on-road vehicle capability by securing the tire to the wheel regardless of the change in tire pressure. The outer bead lock wheel of the present disclosure includes a wheel base having a flange which is operatively configured to receive one of a decorative ring or a functional ring. The decorative ring may be mechanically affixed to the wheel base, and the functional ring may also be mechanically affixed to the wheel base.

### BRIEF DESCRIPTION OF THE DRAWINGS

FIG. 1 is a front view of an embodiment of the outer bead lock wheel of the present disclosure using a decorative ring for a higher pressure tire.

FIG. 2 is a cross sectional view of the embodiment of FIG. 1 along lines A-A.

FIG. 3 is a front view of an embodiment of the outer bead lock wheel of the present disclosure with the functional ring.

FIG. 4 is a cross sectional view of the embodiment of FIG. 3 along lines B-B.

### DETAILED DESCRIPTION

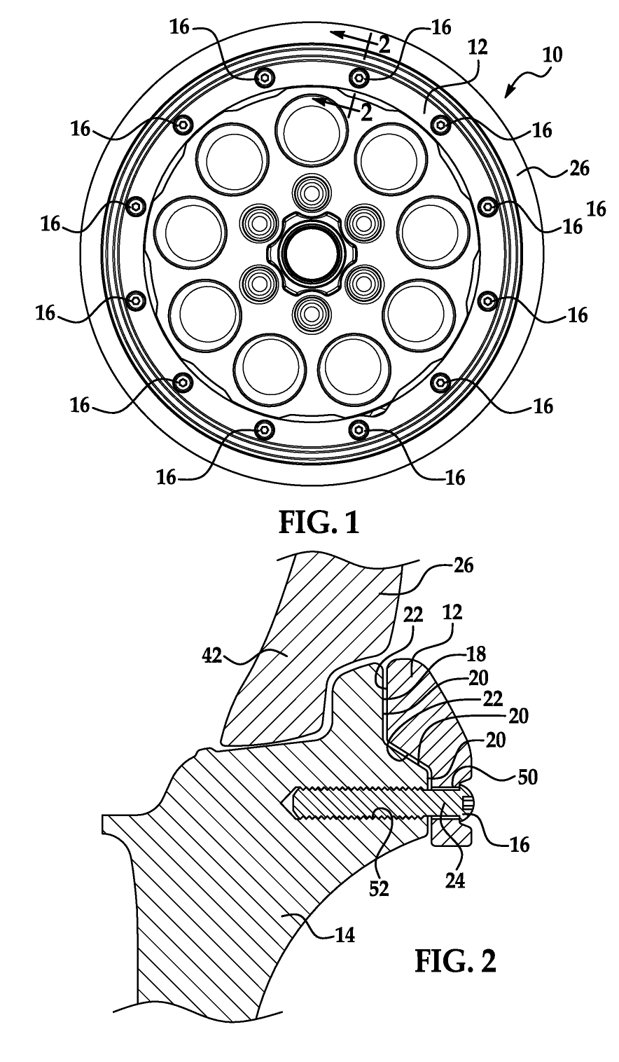

Referring now to FIG. 1, a front view of an embodiment of the outer bead lock wheel 10 of the present disclosure is shown where the outer bead lock wheel 10 is implementing a decorative ring 12. The decorative ring 12 may be desirable when the vehicle is being used on a road at a relatively higher pressure.

In this embodiment, the outer bead lock wheel 10 of the present disclosure includes a wheel base 14 formed of a metal such as steel, aluminum or an alloy. As shown, the wheel base 14 and the decorative ring 12 may implement approximately twelve mechanical fasteners 16 given that the decorative ring 12 is not a load bearing ring. The mechanical fasteners 16 may fasten either the decorative ring 12 or the functional ring 30 by inserting mechanical fasteners in apertures 50. The decorative ring 12 may be formed of aluminum. However, in such an event, the wheel base 14 is also likely to be formed of aluminum as well.

The mechanical fasteners 16 may fasten either the decorative ring 12 or the functional ring 30 to the wheel base 14 by inserting mechanical fasteners 16 in apertures 50 (or bores 52) defined in the wheel base 14, the functional ring 30 and the decorative ring 12 as shown in FIGS. 2 and 4.

Referring now to FIG. 2, the wheel base 14 may define a base flange 18 as shown. It is to be understood that the base flange 18 may have varying configurations. An non-limiting example of a base flange 18 configuration is shown in FIG. 2. As shown, the wheel base 14 may be operatively configured to receive one of a decorative ring 12 or a functional ring 30. In FIGS. 1 and 2, a decorative ring 12 is illustrated wherein and a plurality of mechanical fasteners 16 engage the wheel base 14 to the decorative ring 12. It is also to be understood that although the wheel base 14 may define approximately 24 apertures to receive mechanical fasteners 16, the wheel base 14 may only implement approximately 12 fasteners to affix the decorative ring 12 to the wheel base 14 given that the decorative ring 12 is not a load bearing member.

As shown in FIG. 2, a cross sectional view of the outer bead lock wheel 10 is shown where the outer surface 20 of the base flange 18 of the wheel base 14 is configured abut an inner surface of the decorative ring 12. The outer surface 20 of the base flange 18 may be designed to mate against the entire inner surface 22 of the decorative ring 12 to provide a tight fit between the decorative ring 12 and the wheel base 14 as shown.

Moreover, in the non-limiting example of FIG. 2, internal hex fasteners 24 may be used as the mechanical fasteners 16 between the decorative ring 12 and the wheel base 14. As shown, the outer bead lock wheel 10 using the decorative ring 12 may be used and are configured to secure a high pressure tire 26 against an outer surface 20 of the base flange 18.

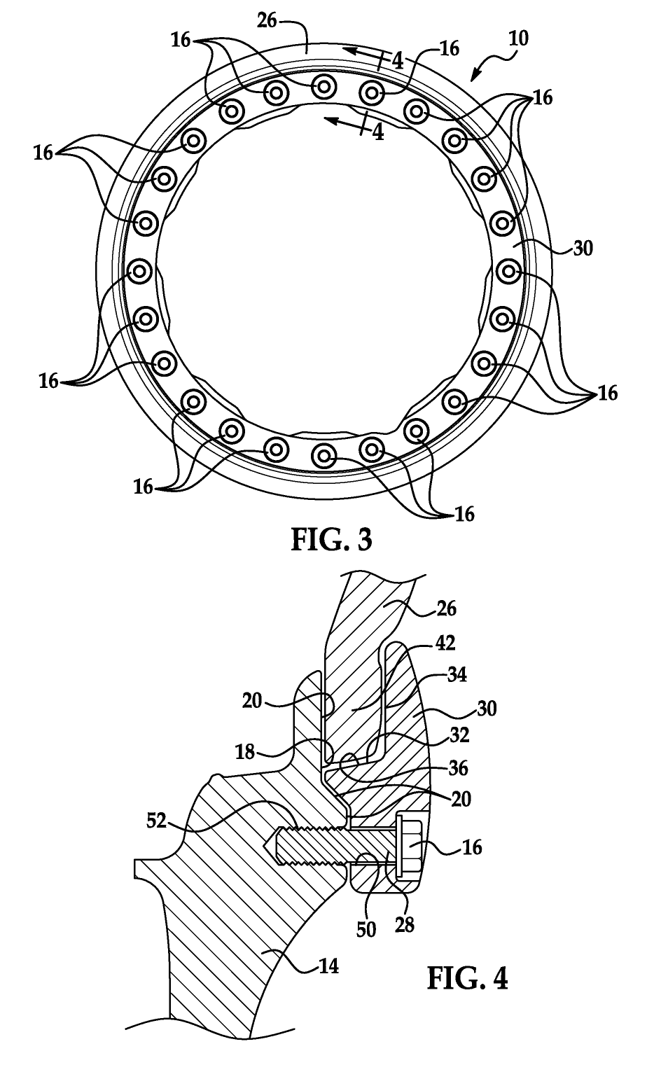

Referring now to FIG. 3, a front view of an embodiment of the present disclosure is shown using a functional ring 30. As shown, approximately all mechanical fasteners 16 must be used together with the functional ring 30 in order to provide proper load bearing capability.

With reference to FIG. 4, a cross sectional view of the embodiment in FIG. 3 is shown along lines B-B. As shown, the functional ring 30 defines a substantially horizontal surface 32 and a substantially vertical surface 34.

The horizontal surface 32 and the vertical surface of the functional ring 30 form a recess 36 wherein the recess 36 is operatively configured to receive a lower edge 42 of a relatively lower pressure tire 26. As tire pressure is decreased, it is desirable to clamp or lock the tire 26 in position to prevent separation between the tire 26 and the wheel in an off-road driving condition.

With reference to FIG. 4, a cross sectional view of one of the plurality of mechanical fasteners 16 is also shown. A flange of the relatively lower pressure tire 26 may be compressed within the recess 36 as the plurality of mechanical fasteners 16 (or a fastening means) between functional ring 30 and the wheel base 14 is tightened. By compressing the flange of the relatively lower pressure tire 26, the tire 26 is secured in place to prevent separation.

It is to be understood that the decorative ring 12 may be formed from a variety of materials, including but not limited to aluminum or steel. The functional ring 30 may be an anodized ring in yet another non-limiting example. Furthermore, in yet a few non-limiting examples, the fastening means 40 or the plurality of mechanical fasteners 16 may be either internal hex fasteners 24 or M10 Washer fasteners 28. However, other fastening means may be implemented which mechanically tighten either the decorative ring 12 or the functional ring 30 to the wheel base 14.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An outer bead lock wheel comprising:
a wheel base defining a base flange, the wheel base being operatively configured to receive one of a decorative ring or a functional ring; and
a plurality of mechanical fasteners engaging the wheel base to one of a decorative ring or a functional ring.

2. The outer bead lock wheel as defined in claim 1 wherein an outer surface of the base flange of the wheel base is configured abut an inner surface of the decorative ring.

3. The outer bead lock wheel as defined in claim 1 wherein the decorative ring and the wheel base are configured to secure a high pressure tire against an inner surface of the base flange when the decorative ring and the wheel base are affixed to one another.

4. The outer bead lock wheel as defined in claim 1 wherein the functional ring defines a substantially horizontal surface and a substantially vertical surface.

5. The outer bead lock wheel as defined in claim 4 wherein a recess is formed by the horizontal surface, the vertical surface and an outer surface of the base flange.

6. The outer bead lock wheel as defined in claim 4 wherein a low pressure tire is affixed within the recess.

7. The outer bead lock wheel as defined in claim 6 wherein a flange of the low pressure tire is compressed within the recess as the plurality of mechanical fasteners between functional ring and the wheel base are tightened.

8. The outer bead lock wheel as defined in claim 1 wherein the decorative ring is formed from aluminum.

9. The outer bead lock wheel as defined in claim 3 wherein the plurality of mechanical fasteners are internal hex fasteners.

10. The outer bead lock wheel as defined in claim 7 wherein the plurality of mechanical fasteners are M10 Washer fasteners.

11. The outer bead lock wheel as defined in claim 10 wherein the functional ring is an anodized ring.

12. An outer bead lock wheel comprising:
a wheel base defining a base flange, the wheel base being operatively configured to receive one of a decorative ring or a functional ring; and
a fastening means for engaging the wheel base to one of a decorative ring or a functional ring.

13. The outer bead lock wheel as defined in claim 12 wherein an outer surface of the base flange of the wheel base is configured abut an inner surface of the decorative ring.

14. The outer bead lock wheel as defined in claim 12 wherein the decorative ring and the wheel base are configured to secure a high pressure tire against an inner surface of the base flange when the decorative ring and the wheel base are affixed to one another.

15. The outer bead lock wheel as defined in claim 12 wherein the functional ring defines a horizontal surface and a vertical surface.

16. The outer bead lock wheel as defined in claim 15 wherein a recess is formed by the horizontal surface, the vertical surface and an outer surface of the base flange.

17. The outer bead lock wheel as defined in claim 15 wherein a low pressure tire is affixed within the recess.

18. The outer bead lock wheel as defined in claim 17 wherein a flange of the low pressure tire is compressed within the recess as the fastening means between the functional ring and the wheel base is tightened.

19. The outer bead lock wheel as defined in claim 12 wherein the decorative ring is formed from aluminum.

20. The outer bead lock wheel as defined in claim 14 wherein the fastening means is a plurality of internal hex fasteners.

21. The outer bead lock wheel as defined in claim 18 wherein the fastening means is a plurality of M10 Washer fasteners.

22. The outer bead lock wheel as defined in claim 21 wherein the functional ring is an anodized ring.
